(19) United States
(12) Patent Application Publication
(10) Pub. No.: US 2006/0049184 A1
(43) Pub. Date: Mar. 9, 2006

(54) Microwave-based hydronics heating system

(75) Inventor: Dennis P. Garboski, Bedford, NH (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: DTI Innovations, LLC, Salem, NH (US)

(21) Appl. No.: 10/924,154

(22) Filed: Aug. 23, 2004

(51) Int. Cl. H05B 6/80

(52) U.S. Cl. 219/688

(57) ABSTRACT

A heating system includes a first fluid circulation system having tubing for conveying fluid, a pump for moving the fluid through the tubing of the first fluid circulation system, and a microwave system that heats the fluid passing through the tubing. The amount of fluid circulating in the first fluid circulation system approximates less than a gallon. A second fluid circulation system has tubing for conveying fluid and a pump for moving this fluid through the tubing of the second fluid circulation system. A heat exchanger, connected to the tubing of the first fluid circulation system and to the tubing of the second fluid circulation system, the heat exchanger transfers heat from the fluid in the first fluid circulation system to the fluid in the second fluid circulation system.

### FIELD OF THE INVENTION

The invention relates generally to hydronics heating systems. More specifically, the invention relates to hydronics heating systems that heat fluid using microwave energy.

### BACKGROUND

Common methods for heating a home include natural gas, oil, and electricity. Because of the rising costs of these resources, home heating has become a significant expense in many households. One type of heating system commonly used to heat a home is a hot water system. Hot water systems typically rely on a hot water boiler that circulates hot water through a system of pipes connected to radiators or baseboards located throughout the house. The water in the boiler is usually heated by burning oil or natural gas. Typically, however, the boiler contains tens of gallons of water, which require a significant expenditure of energy to bring this entire reservoir to a desired temperature (e.g., 160 to 190 degrees).

Typically, the water boiler is also a source of hot water for other purposes within the house, such as washing, cooking, and showering. The desired water temperature for heating the home, however, is often far in excess of the water temperature permitted to pass to the faucets and showerheads. To bring the water temperature within acceptable range before the water reaches the faucets, hot water systems use mixers to mix cold water with the hot water from the boiler. The energy and cost expended initially to raise the water to the desired temperature for heating the home is thereby wasted. Thus, there is a need for an inexpensive home heating system without the aforementioned disadvantages.

### SUMMARY

In one aspect, the invention features a heating system comprising a first fluid circulation system having tubing for conveying fluid, a first pump moving the fluid through the tubing of the first fluid circulation system, and a microwave system that heats the fluid passing through the tubing. The amount of fluid circulating in the first fluid circulation system is less than a gallon. A second fluid circulation system, separate from the first fluid circulation system, has tubing for conveying fluid and a second pump for moving this fluid through the tubing of the second fluid circulation system. A heat exchanger, connected to the tubing of the first fluid circulation system and to the tubing of the second fluid circulation system, transfers heat from the fluid in the first fluid circulation system to the fluid in the second fluid circulation system.

In another aspect, the invention features a heating system, comprising a first fluid circulation system having means for conveying fluid, a first means for circulating the fluid in the first fluid circulation system, and means for generating microwave energy that heats the fluid circulating through the first fluid circulation system. The amount of fluid circulating in the first fluid circulation system approximating less than a gallon. A second fluid circulation system, separate from the first fluid circulation system, has means for conveying fluid to an element to be heated. A means for transferring heat transfers heat from the fluid circulating in the first fluid circulation system to the fluid circulating in the second fluid circulation system.

In still another aspect, the invention features a method for circulating heat through a heating system. A first quantity of fluid of approximately less than a gallon is circulated through a first fluid circulation system. The fluid circulating in the first fluid circulation system is heated by exposing the fluid to microwave radiation. A second quantity of fluid is circulated through a second fluid circulation system to an element to be heated. Heat from the fluid circulating through the first fluid circulation system is transferred to the fluid moving through the second fluid circulation system to heat the element.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of an embodiment of a hydronics heating system constructed in accordance with the invention.

FIG. 2 is a block diagram of another embodiment of a hydronics heating system of the invention.

FIG. 3 is a block diagram of still another embodiment of a hydronics heating system of the invention.

FIG. 4 is a block diagram of yet another embodiment of the hydronics heating system.

FIG. 5 is a front view of an embodiment of a microwave system having a replaceable microwave unit for heating fluid in a hydronics heating system of the invention.

### DETAILED DESCRIPTION

The present invention features a microwave-based hydronics heating system. In general, hydronics is a system of heating or cooling that involves the transfer of heat through the circulation of a fluid, for example, water or vapor, in a closed system of tubing or pipes. The hydronics system of the present invention circulates microwave-heated fluid in a first closed system. This fluid is heated while circulating through the first closed system. Heat from this microwave-heated fluid transfers to fluid circulating in a second closed system. The heat of the fluid circulating in the second closed system is then used to heat a target place, object or thing, for example, a room in a home, a pool, a spa, PEX-lined flooring, or a PEX-lined driveway. Preferably, the amount of fluid heated by microwave energy and circulated in the first closed system is small, preferably less than a gallon, so that the fluid can reach a desired temperature with a brief exposure to microwaves. When used to heat a home, a hydronics heating system of the present invention can advantageously remain independent (i.e., separate) from any heating system and associated plumbing used in producing and carrying hot water (i.e., for use in the residence for washing, bathing, and cooking).

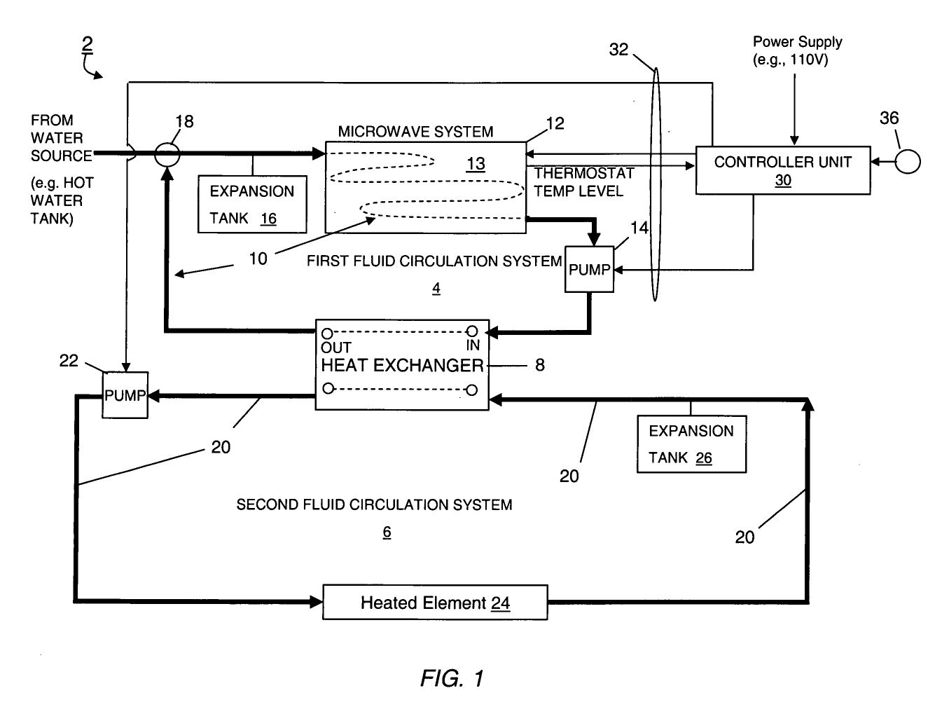

FIG. 1 shows an embodiment of a heating system 2 of the invention. The heating system 2 includes a first fluid circulation system 4 in thermal communication with a second fluid circulation system 6 through a heat exchanger 8. Each fluid circulation system 4, 6 is an independent, closed system of tubing or pipes. The first fluid circulation system 4 includes tubing 10 for transporting fluid (e.g., water), a microwave system 12, and a pump 14 for circulating fluid through the tubing 10. In one embodiment, the tubing 10 is ¾ inch diameter PEX tubing (i.e., cross-linked polyethylene). Vanex® PEX, manufactured by Vanguard Piping Systems, Inc of McPherson, Kans., is an example of PEX tubing that can be used to practice the invention. Other types of microwave-penetrable tubing can be used, for example glass, to practice the invention. This microwave system 12 includes a magnetron (not shown) for generating microwaves and a chamber 13, into which the microwaves radiate. A 1 kW magnetron, for example, can be used to practice the invention. The pump 14 can be implemented by a model number 006-B4 Taco Pump manufactured by Taco of Cranston, R.I. Although not shown, each circulation system 4, 6 can also have one or more pressure-relief valves.

One section of the tubing 10 extends from a valve 18 through the chamber 13 of the microwave system 12 to an input port of the pump 14. The portion of tubing 10 extending through the chamber 13 is exposed to the microwave energy generated by the microwave system 12. The tubing material permits microwave energy to heat the fluid carried therethrough. The tubing 10 is also flexible so that it may be bent in serpentine fashion within the chamber 13. Bending enables more tubing to be exposed to the microwaves emitted by the microwave system 12, thus increasing the quantity of fluid that can be concurrently heated than if the tubing 10 passes straight through the chamber 13. Preferably, the length of this heated section of tubing 10 ranges from approximately two feet to approximately three feet, although this length can be varied without departing from the principles of the invention.

A second section of tubing 10 connects an output port of the pump 14 to an input port of the heat exchanger 8, and a third section of tubing 10 connects an output port of the heat exchanger 8 to the valve 18. The amount of tubing 10 in the first fluid circulation system 4 can measure approximately five feet or less. The particular order in which the elements appear in the first fluid circulation system 4 is exemplary; the elements can appear in a different position within the first fluid circulation system 4 without departing from the principles of the invention. Also, although in FIG. 1 the first fluid circulation system 4 is shown to be a single loop, it is to be understood that the principles of the invention apply to more complex tubing (or plumbing) configurations. Optionally, an expansion tank 16 is connected to the third section of tubing 10, to allow for fluid expansion as the fluid is heated by the microwave system 12.

A source of fluid (e.g., a hot water tank) initially supplies the fluid that circulates through the first fluid circulation system 4. The valve 18 is in an open position to fill and refill the tubing 10 and in a closed position when the first fluid circulation system 4 is filled to its desired capacity. Approximately one cup to one gallon of fluid circulates through the first fluid circulation system 4 at any one time. This low quantity of fluid, relative to conventional hot water storage tanks, which typically hold tens of gallons of water, enables the fluid to heat rapidly to achieve a target temperature. For example, in one embodiment, 1.5 cups of water circulated through the first fluid circulation system 4 and the microwave system 12 was able to heat the water to 140 degrees Fahrenheit in less than two minutes.

The second fluid circulation system 6 includes tubing 20 for transporting fluid, a pump 22 for circulating the fluid through the tubing 20, a heated element 24, and an optional expansion tank 26. The fluid can be a liquid, such as water, or a gas, such as vapor or air. The tubing 20 can also be ¾ inch diameter PEX tubing, as described above. One section of tubing 20 connects a second output port of the heat exchanger 8 to an input port of the pump 22, a second section of tubing 20 connects an output port of the pump 22 to an input of the heated element 24, and a third section of tubing connects the heated element 24 to an input port of the heat exchanger 8. Again, the arrangement of elements is exemplary; the location in which these elements appear in the second fluid circulation system 6 can vary without departing from the principles of the invention. For embodiments in which the fluid is water, the optional expansion tank 26 can be connected to the third section of tubing 20, for example, to permit the water to expand during heating.

Implementations of the heated element 24 vary, based on the particular application for which the invention is used. For a home heating system, the heated element 24 can be one or more baseboard heaters located in a room of the home. Each baseboard heater radiates heat from the fluid passing therethrough. In other embodiments, the heated element 24 is a reservoir of water, for example, as that in a swimming pool or in a spa. In still other embodiments, the heated element 24 is PEX-lined flooring, a sidewalk, or a PEX-lined driveway. Other types of heated elements can be used without departing from the principles of the invention.

The heat exchanger 8 transfers the heat from the fluid circulating in the first fluid circulation system 4 to the fluid circulating in the second fluid circulation system 6. In one embodiment, the heat exchanger 8 is implemented by a liquid-to-liquid TFP5×12-4 heat exchanger manufactured by Taco. A liquid-to-air heat exchanger can be used when the second fluid circulation system 6 circulates air. Preferably, the fluid circulating in the first fluid circulation system 4 flows in the same direction through the heat exchanger 8 as the fluid flowing in the second fluid circulation system 8 to enhance the heat transfer between the fluids.

The heating system 2 also includes a microprocessor-based controller unit 30 in electrical communication with the microwave system 12, with the pump 14 in the first fluid circulation system 4, with the pump 22 in the second fluid circulation system 8, and with a thermostat 36. The controller unit 30 receives fluid temperature readings from the microwave system 12 and room temperature readings from the thermostat 36, which can be located in a room being heated. The controller unit 30 is powered by a 110 volt power source. A Taco SR 502 controller unit can be used to implement the controller unit 30.

During an exemplary operation of the heating system 2, the controller unit 30 determines when the microwave system 12 and pumps 14, 22 are on and off, based on temperature readings from the room thermostat 36 and from a thermocouple or thermostat measuring the temperature of the fluid in the first fluid circulation system 4. Consider as an initial point that the microwave system 12 and pumps 14, 22 are in an off state. When the thermostat 36 determines that the temperature of the room has fallen below a desired set point, the controller unit 30 sends signals to turn on the microwave system 12 and the pumps 14, 22. These signals can be timed or delayed such that the microwave system 12 runs for a predetermined time before the pumps 14, 22 start to operate.

The microwave system 12 heats the fluid passing through the tubing 10 within the chamber 13 until the fluid in the first fluid circulation system 4 reaches a certain temperature (e.g., 180 to 190 degrees). The thermostat of the microwave system 12 (not shown) determines that the fluid has attained the certain temperature and signals the controller unit 30. Alternatively, a thermocouple connected to the tubing 10 can measure the fluid temperature. After this fluid reaches the target temperature, the controller unit 30 turns the microwave system 12 off. The pump 14 can continue to operate for some time after the microwave system 12 turns off to ensure that the heated fluid continues to circulate through the heat exchanger 8. If the fluid temperature in the first fluid circulation system 4 drops below a desired set point, the controller unit 30 can turn on the microwave system 12 again to resume heating the fluid.

While the fluid in the first fluid circulation system 4 remains hotter than the fluid in the second fluid circulation system 6, the heat exchanger 8 continuously transfers the heat to the fluid in the second fluid circulation system 6. The pump 22 moves this fluid to the heated element 24. The thermostat 36 subsequently signals the controller unit 30 when the measured object (e.g., a room) reaches the desired temperature. In response, the controller unit 30 can signal the microwave system 12 and the pumps 14, 22 to turn off.

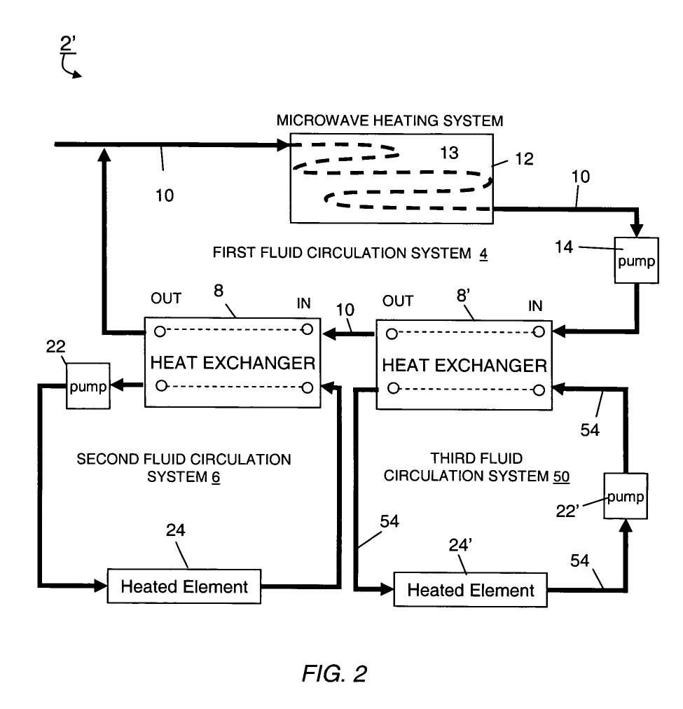

FIG. 2 shows another embodiment of a hydronics heating system 2′ having a third fluid circulation system 50 and a second heat exchanger 8′ in addition to the first and second fluid circulation systems of FIG. 1. Expansion tanks, shut-off valve, and controller unit are not shown to simplify the illustration. The third fluid circulation system 50 includes tubing 54 for transporting fluid, a pump 22′ for circulating the fluid through the tubing 54, and a heated element 24′. One section of the tubing 54 connects an output port of the heat exchanger 8′ to the heated element 24, a second section of tubing 54 connects the heated element 24 to an input port of the pump 22′, and a third section of tubing 54 connects an output port of the pump 22′ to an input port of the heat exchanger 8′.

In this embodiment, one section of the tubing 10 of the first fluid circulation system 4 extends from the first heat exchanger 8 through the chamber 13 of the microwave system 12 to the input port of the pump 14. A second section of tubing 10 connects an output port of the pump 14 to an input port of the second heat exchanger 8′. A third section of tubing 10 connects an output port of the second heat exchanger 8′ to the input port of the first heat exchanger 8.

The microwave system 12 heats the fluid passing through the section of tubing 10 within the chamber 13. The pump 14 moves this microwave-heated fluid to the second heat exchanger 8′. The second heat exchanger 8′ transfers heat from the microwave-heated fluid to the fluid circulating in the third fluid circulation system 50. The heating of the fluid in the third fluid circulation system 50 is used to heat the heated element 24′. The microwave-heated fluid then passes through the second heat exchanger 8′ to the first heat exchanger 8, which transfers heat from the microwave-heated fluid to the fluid circulating in the second fluid circulation system 6. The heating of the fluid in the second fluid circulation system 6 is used to heat the heated element 24.

This embodiment achieves separate heating zones (e.g., rooms in a residence). Control of the operation of the microwave system 12 and of the pumps 14, 22, 22′ can be managed so that heating one zone can occur independently of the heating of another zone. For example, turning off pump 22′ while turning on pump 22 can transfer heat to the heated element 24 in the second fluid circulation system 6 without transferring heat to the heated element 24′ in the third fluid circulation system 50.

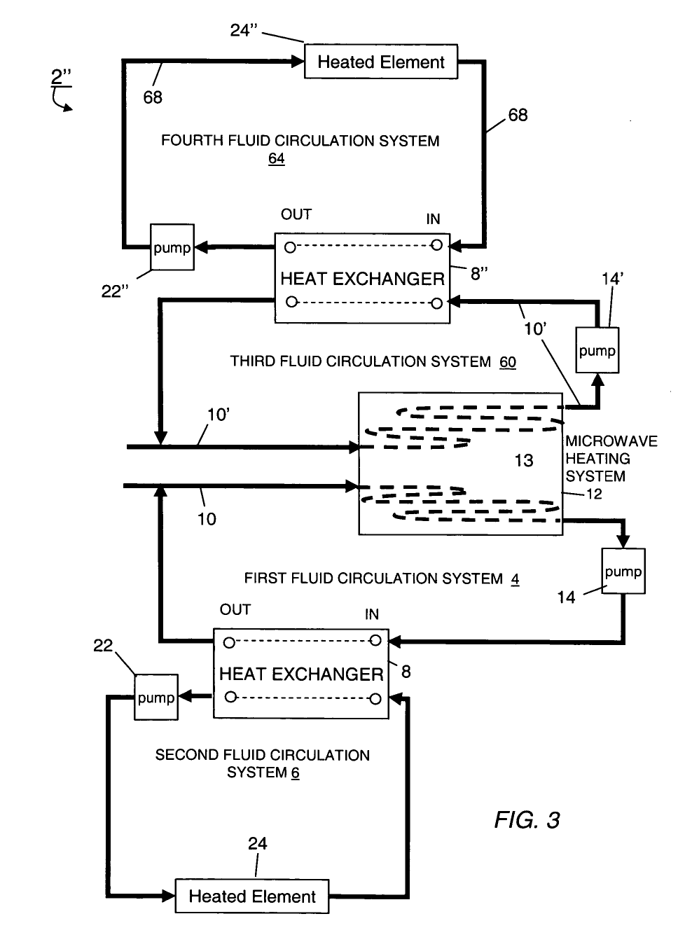

FIG. 3 shows another embodiment of a hydronics heating system 2″ having a third fluid circulation system 60, a fourth fluid circulation system 64, and a second heat exchanger 8″ in addition to the first and second fluid circulation systems of FIG. 1. Again, expansion tanks, shut-off valve, and controller unit are not shown to simplify the illustration. The third fluid circulation system 60 includes tubing 10′ for transporting fluid, a pump 14′ for circulating the fluid through the tubing 10′, and the microwave system 12. One section of the tubing 10′ passes through the chamber 13 of the microwave system 12.

The fourth fluid circulation system 64 includes tubing 68 for transporting fluid, a pump 22″ for circulating the fluid through the tubing 68, and a heated element 24″. One section of the tubing 68 connects an output port of the heat exchanger 8″ to the heated element 24″, a second section of tubing 68 connects the heated element 24″ to an input port of the pump 22″, and a third section of tubing 68 connects an output port of the pump 22″ to an input port of the heat exchanger 8″.

In this embodiment, the microwave system 12 can concurrently heat fluid circulating in the first fluid circulation system 4 and fluid in the third fluid circulation system 60. Microwave-heated fluid in the first fluid circulation system 4 passes through the first heat exchanger 8, and the first heat exchanger 8 transfers heat from the fluid to the second fluid circulation system 6 for use in heating the heated element 24. Independent of the fluid in the first fluid circulation system 4, microwave-heated fluid in the third fluid circulation system 60 passes through the second heat exchanger 8″, which transfers heat from this microwave-heated fluid to the fourth fluid circulation system 64 for use in heating the heated element 24″.

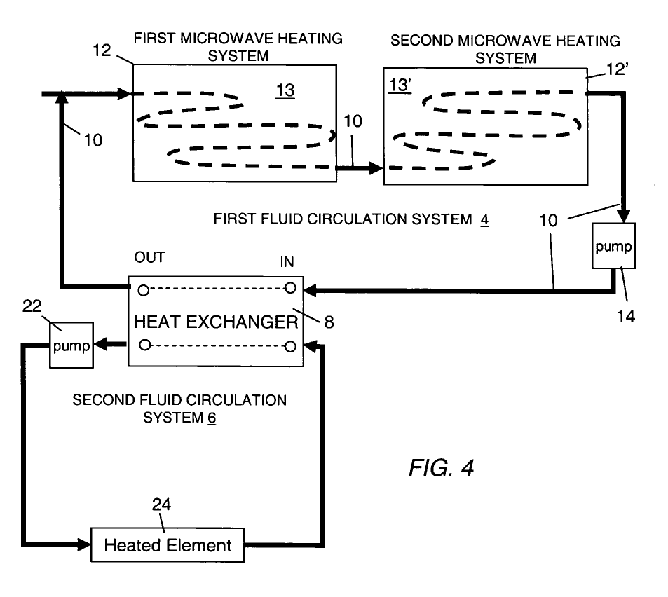

FIG. 4 shows another embodiment of a hydronics heating system 2′″ having a second microwave system 12′ in the first fluid circulation system 4 of FIG. 1 in addition to the first microwave system 12. Expansion tanks, shut-off valve, and controller unit are not shown. One section of tubing 10 extends from the first heat exchanger 8 through the chamber 13 of the first microwave system 12 and through the chamber 13′ of the second microwave system 12′ to the input port of the pump 14. Each microwave system 12, 12′ can be independently controlled; one or both systems 12, 12′ can be turned on to heat the fluid passing through the tubing 10 of the first fluid circulation system. Having more than one microwave system 12 can raise the fluid to a desired temperature more quickly than the one microwave system 12 alone.

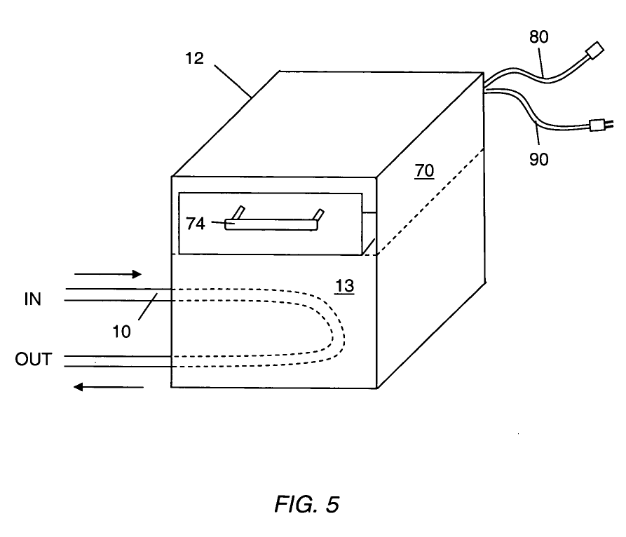

FIG. 5 shows an embodiment of the microwave system 12 having a chamber 13 and an owner-replaceable microwave unit 70. In the embodiment shown, the microwave unit 70 can slide into and out of the microwave system 12 like a desk drawer. A front face of the drawer can have a handle 74 to facilitate installation and removal of the microwave unit 70 by the owner or by field service personnel. Other owner-replaceable configurations within the microwave system 12 can be implemented without departing from the principles of the invention (e.g., replaced from the top or from the back of the microwave system 12). The microwave unit 70 contains the magnetron for generating the microwaves that heat fluid traveling through the tubing 10 within the chamber 13. A cable 80 connects the microwave unit 70 to the controller unit 30 (FIG. 1) and an electrical plug 90 connects the microwave unit 70 to a power supply (e.g., 110 v). The microwave unit 70 does not operate without being connected to the controller unit 30, which may ensure that any microwave unit 70 that is removed from the microwave system 12 cannot be used elsewhere.

Although the invention has been shown and described with reference to specific preferred embodiments, it should be understood by those skilled in the art that various changes in form and detail may be made therein without departing from the spirit and scope of the invention as defined by the following claims.

What is claimed is:

1. A heating system, comprising:
a first fluid circulation system having tubing for conveying fluid, a first pump for moving the fluid through the tubing of the first fluid circulation system, and a microwave system that heats the fluid passing through the tubing, an amount of fluid circulating in the first fluid circulation system approximating less than a gallon;
a second fluid circulation system separate from the first fluid circulation system, the second fluid circulation system having tubing for conveying fluid and a second pump for moving this fluid through the tubing of the second fluid circulation system; and
a heat exchanger connected to the tubing of the first fluid circulation system and to the tubing of the second fluid circulation system, the heat exchanger transferring heat from the fluid in the first fluid circulation system to the fluid in the second fluid circulation system.

2. The heating system of claim 1, further comprising a controller unit in communication with the microwave system to control when the microwave system is operating.

3. The heating system of claim 1, wherein the second fluid circulation system includes a baseboard heater for heating an area of housing structure.

4. The heating system of claim 1, wherein the second fluid circulation system includes a reservoir of fluid.

5. The heating system of claim 1, wherein the section of tubing in which the microwave system heats the fluid has a length ranging from approximately two feet to approximately four feet.

6. The heating system of claim 1, wherein the tubing of the second fluid circulation system passes through flooring.

7. The heating system of claim 1, further comprising:
a third circulation system separate from the first and second fluid circulation systems, the third circulation system having tubing for conveying fluid and a third pump for moving this fluid through the tubing of the third circulation system; and
a second heat exchanger connected to the tubing of the first fluid circulation system and to the tubing of the third circulation system, the heat exchanger transferring heat from the fluid moving through the first fluid circulation system to the fluid moving through the third circulation system.

8. The heating system of claim 7, wherein the microwave system heats fluid passing through a section of the tubing of the third circulation system.

9. The heating system of claim 1, wherein the first fluid circulation system includes a second microwave system for heating another section of the tubing in the first fluid circulation system.

10. The heating system of claim 1, wherein the microwave system includes a chamber through which a section of the tubing passes and a removable microwave unit for heating fluid in the section of tubing.

11. A heating system, comprising:
a first fluid circulation system having means for conveying fluid, a first means for circulating the fluid through the first fluid circulation system, and means for generating microwaves that heats the fluid circulating in the first fluid circulation system, an amount of fluid circulating in the first fluid circulation system approximating less than a gallon;
a second fluid circulation system separate from the first fluid circulation system, the second fluid circulation system having means for conveying fluid to an element to be heated; and
means for transferring heat from the fluid circulating in the first fluid circulation system to the fluid circulating in the second fluid circulation system.

12. The heating system of claim 11, further comprising means for controlling when the microwave system is operating based on a temperature.

13. The heating system of claim 11, wherein the element to be heated includes a baseboard heater.

14. The heating system of claim 11, wherein the element to be heated includes a reservoir of fluid.

15. The heating system of claim 11, wherein the element to be heated includes flooring.

16. The heating system of claim 11, further comprising:
a third fluid circulation system separate from the first and second fluid circulation systems, the third fluid circulation system means for conveying fluid to a second element to be heated; and
second means for transferring heat from the fluid circulating in the first fluid circulation system to the fluid circulating in the third circulation system.

17. The heating system of claim 11, wherein the first fluid circulation system includes a second means for generating microwave energy that heats the fluid circulating through the first fluid circulation system.

18. The heating system of claim 11, wherein the means for generating microwaves includes a removable microwave unit.

19. A method for circulating heat through a heating system, comprising:
circulating through a first fluid circulation system a first quantity of fluid of approximately less than a gallon;
heating the fluid circulating through the first fluid circulation system by exposing the fluid to microwave radiation;
circulating a second quantity of fluid through a second fluid circulation system to an element to be heated; and
transferring heat from the fluid circulating through the first fluid circulation system to the fluid moving through the second fluid circulation system to heat the element.

20. The method of claim 19, further comprising heating a baseboard heater with the fluid circulating in the second fluid circulation system.

21. The method of claim 19, further comprising heating a reservoir of water with the fluid circulating in the second fluid circulation system.

22. The method of claim 19, further comprising heating flooring with the fluid circulating in the second fluid circulation system.
